(19) United States
(12) Patent Application Publication
(10) Pub. No.: US 2024/0422499 A1
(43) Pub. Date: Dec. 19, 2024

(54) METHOD AND SYSTEM OF VIRTUALIZED SPATIAL AUDIO

(71) Applicant: HARMAN INTERNATIONAL INDUSTRIES, INCORPORATED, Stamford, CT (US)

(72) Inventors: Pingzhan LOU, Shenzhen (CN); Shao-Fu SHIH, Mountain View, CA (US); Jianwen ZHENG, Shenzhen (CN)

(73) Assignee: HARMAN INTERNATIONAL INDUSTRIES, INCORPORATED, Sttamford, CT (US)

(21) Appl. No.: 18/822,216

(22) Filed: Sep. 1, 2024

Related U.S. Application Data
(63) Continuation of application No. PCT/CN2022/078598, filed on Mar. 1, 2022.

(51) Int. Cl. H04S 7/00

(52) U.S. Cl. CPC H04S 7/303

(57) ABSTRACT

The disclosure relates to a method and system of virtualized spatial audio. The method may use a motion sensor to track a listener's movement, obtain location information associated with the listener's movement, and produce virtual sound adaptively based on the location information associated with the listener's movement. The location information may include distance information and direction information regarding the listener relative to the motion sensor.

### CROSS-REFERENCE TO RELATED APPLICATION

This application is a continuation of International Application No. PCT/CN22/078598, filed on Mar. 1, 2022, the disclosure of which is incorporated by reference herein.

### TECHNICAL FIELD

The present disclosure relates to audio processing, and specifically relates to a method and system of virtualized spatial audio based on tracking for ambiguous listening location.

### BACKGROUND

The interest of realizing virtual reality is growing in various applications. Users expect better immersive experience with three-dimensional audio for video games, movies, and remote educations. The 3D audio effect could be achieved with virtual sound by utilizing multi-channel audio system consisting of multiple speakers together with object-based audio to simulate the virtual source at supposed locations.

In theory, the audio system should produce the same sound field as the virtual source so the listener can perceive the virtualized sound source accurately. These virtual surround methods aim at mimicking the sound field around user's listening position to the one from the intended 3D reproduction space. A delicate reproduction method is needed for the audio system to produce the virtual sound field with high-fidelity. Thus, the listener can intuitively feel that the sound coming from the virtual source without physical speakers in present.

The current techniques only enable the virtual surround sound reproduction at the listeners' head, not in the whole space. Thus, the so called ‘sweet spot’, the ideal listening area, when producing virtual sound is usually very small, and limited to the listener's head and ears. When the listener moves out of the sweet spot, the virtual sound effect is no longer available. It makes things worse that the reproduced sound field is unpredictable outside the sweet spot and sometimes the sound is strange and unnatural. Thus, one of the challenges of the virtual surround is the ‘sweet spot’ from trying to closely mimic the sound field around the listener's head because the ‘sweet spot’ is known to be more sensitive to head position, while a listener could be moving and swinging during playing the games and movies hence not anchored to the set location.

Therefore, it would be beneficial to know the exact location of the listener so that the audio system can shift the sweet spot with the listener's movement.

### SUMMARY

According to one aspect of the disclosure, a method of virtualized spatial audio is provided. The method may use a motion sensor to track a listener's movement, obtain location information associated with the listener's movement, and produce virtual sound adaptively based on the location information associated with the listener's movement. The location information may include distance information and direction information regarding the listener relative to the motion sensor.

According to another aspect of the present disclosure, a system of virtualized spatial audio is provided. The system may comprise a motion sensor and a processor. The motion sensor may be configured to track a listener's movement. The audio system may be configured to obtain location information associated with the listener's movement based on the tracking by the motion sensor, and produce virtual sound adaptively based on the location information associated with the listener's movement. The location information may include distance information and direction information regarding the listener relative to the motion sensor.

According to yet another aspect of the present disclosure, a non-transitory computer-readable storage medium comprising computer-executable instructions is provided which, when executed by a computer, causes the computer to perform the method disclosed herein.

### BRIEF DESCRIPTION OF THE DRAWINGS

FIG. 1 illustrates an example of a system configuration according to one or more embodiments of the present disclosure;

FIG. 2 illustrates a flowchart of the method for producing spatialized virtual sound for moving listeners according to one or more embodiments of the present disclosure;

FIG. 3 illustrates a schematic diagram of signal merging process for virtual sound generation according to one or more embodiments of the present disclosure;

FIG. 4 illustrates a schematic diagram of virtual sound generation with more details according to one or more embodiments of the present disclosure;

FIG. 5 illustrates a detailed example of the virtual sound system fed with audio sources represented by a 7.1 channel decoded in Dolby format; and

FIG. 6 illustrates an example of adaptation of the audio system based on the location tracking according to one or more embodiments.

It is contemplated that elements disclosed in one embodiment may be beneficially utilized on other embodiments without specific recitation. The drawings referred to here should not be understood as being drawn to scale unless specifically noted. Also, the drawings are often simplified and details or components omitted for clarity of presentation and explanation. The drawings and discussion serve to explain principles discussed below, where like designations denote like elements.

### DETAILED DESCRIPTION OF THE PREFERRED EMBODIMENTS

Examples will be provided below for illustration. The descriptions of the various examples will be presented for purposes of illustration but are not intended to be exhaustive or limited to the embodiments disclosed. Many modifications and variations will be apparent to those of ordinary skill in the art without departing from the scope and spirit of the described embodiments.

To provide the listeners with consistent experience of the virtual sound, the listener's location (especially the head position of the listener) needs to be tracked so that the audio system can modify the virtual surround response configurations relative to the location of the listeners.

When considering a person's location tracking, a usual approach is to use optical sensors, such as RGB camera, combined with face recognition. However, the optical camera suffers from environment conditions (shadow, low-light, sunlight, etc.) and cannot get accurate measurement of the distance. Besides, complex processing (such as machine learning based facial tracking algorithms) is needed. More importantly, there are also privacy concerns with the cameras.

In this disclosure, an improved method and system of producing spatialized virtual sound for moving listeners are provided. The method and system proposed in this disclosure combine an audio system with a motion sensor to provide the listener with the same virtual sound effect regardless the listener' movement. Particularly, the motion sensor may track and detect the location of the listener who is moving and estimate location information associated with the listener's movement. The location information is then provided to the audio system so that the resultant sound field can be changed adaptively based on the location information, for example, the information associated with head position. The head position may include direction information and the distance information regarding the listener relative to the motion sensor. By combining the audio system with the motion sensor, the proposed approach enables wider listening position for virtual surround, providing better listening experience. Furthermore, no additional hardware for optical modules or complex algorithms are required, and there are no privacy concerns. The approach will be explained in detail in reference to FIGS. 1-6 as follows.

FIG. 1 illustrates an example of a system configuration according to one or more embodiment of the present disclosure. The system configuration may include an audio system (e.g., soundbar 102 shown in FIG. 1) and a motion sensor 104. As an example, the audio system in FIG. 1 is shown as a soundbar 102 consisting of multiple speakers 106. It can be understood that the audio system may be any system form with speaker array. The exemplary audio system may be a kind of all-in-one soundbar system, and may include, in addition to a speaker array, for example but not limited to, processors, digital to analog converters, amplifiers and so on which are not shown in FIG. 1 for clarity of presentation and explanation. The soundbar 102 may be set up together with a motion sensor 104 on the top center thereof.

The motion sensor 104 may be, for example, a TOF (Time of Flight) camera, a radar, or an ultrasound detector. The TOF camera provides 3-D image by a CMOS array together with an active modulated light source. It works by illuminating the scene with modulated light source (solid-state laser or LED, usually near-infra light invisible to human eyes) and observing the reflected light. The time delay of the light can reflect the distance information, and accordingly the direction information may be obtained. As for the radar, by emitting radio waves and receiving the reflected waved from the listener, the radar can measure the location of the listener, especially the head position, based on the delay and direction of the reflected waves. The motion sensors used in this disclosure have the advantages of robustness in various environments, easy integration with the audio system due to comparatively simple and on-chip processing for target identification and tracking, and no privacy concerns. The motion sensors 104 may keep continuous tracking of the listener (e.g., listener's head) and provide the location information associated with the listener's movement for the soundbar 102 to adapt filter coefficients of the audio system based on the location information. The location information may comprise, for example, the distance R information and direction θ information regarding the listener or the listener's head relative to the motion sensor 104. The all-in-one soundbar system (e.g., soundbar 102) with multiple speakers 106 may synthesize the virtual sound field based on different location information.

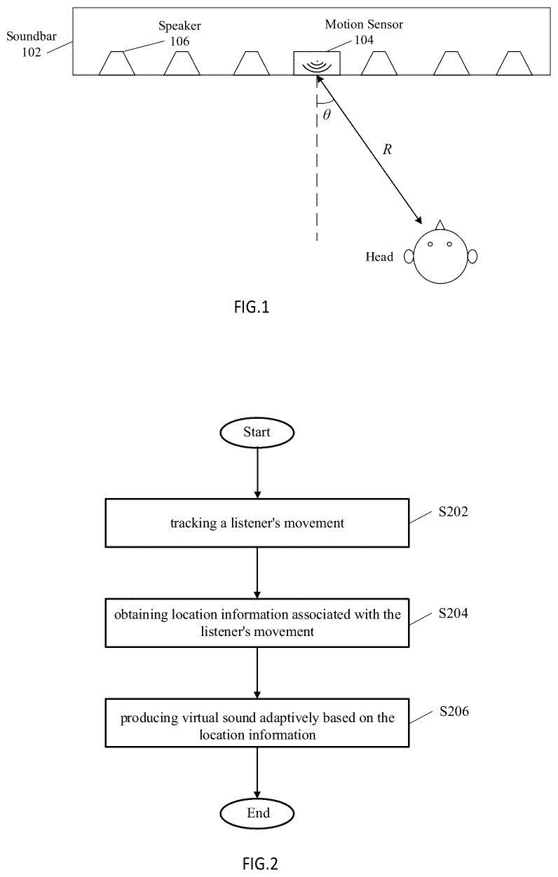

FIG. 2 illustrates a flowchart of the method for producing spatialized virtual sound for moving listeners according to one or more embodiments of the present disclosure. At S202, a listener's movement may be tracked by a motion sensor. At S204, location information associated with the listener's movement may be obtained. The location information includes distance information and direction information regarding the listener relative to the motion sensor. At S206, the soundbar may produce virtual sound adaptively based on the location information associated with the listener's movement.

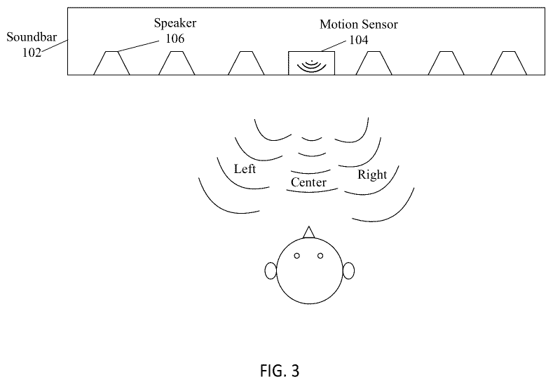

Next, a virtual sound generation method and system will be explained in references to FIGS. 3-6. FIG. 3 illustrates a schematic diagram of signal merging method for virtual sound generation according to one or more embodiment of the present disclosure. The media material of games and movies are first decoded into multi-channel signals. The basic strategy is to merge the multi-channel signals into three channels, as shown in FIG. 3. The signals in the channels from left directions are merged into the left path, and the signals in the channels from the right directions are merged in the right path. In the meantime, the signals in the center are directly generated. In this way, the virtual sound source in front of the listener is reproduced with clearness and high fidelity, and the surround signals are produced to provide the listener with immersive experience.

According to one or more embodiments, the method of producing virtual sound adaptively based on the location information associated with the listener's movement may comprise decoding the audio sources into multi-channel signals. Then, multi-channel signals may be merged into channels of left, center and right path, and the merged signals in left path, center path and right path can be obtained. The merged signals in the left path and the right path may be further processed by spatial filters, wherein coefficients of the spatial filters are adaptively adjusted based on the location information. Finally, the virtual sound may be generated based on the processed signals of the left path and the right path and the signals of the center path not processed by spatial filters.

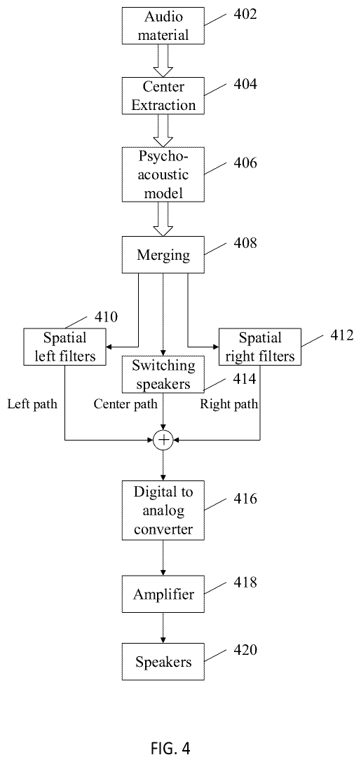

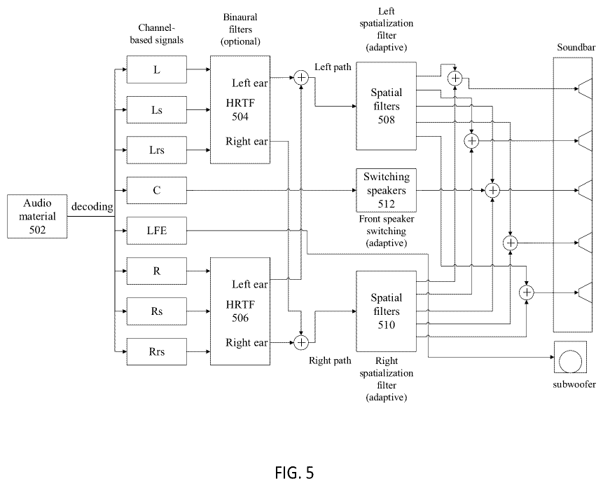

FIG. 4 illustrates a schematic diagram of virtual sound generation with more details according to one or more embodiment. As shown in FIG. 4, at block 402, the audio sources (e.g., audio material) are decoded into multi-channel signals (N-channel signals). The blocks 404, 406 of center extraction and psycho-acoustic model shown in FIG. 4 are optional. For the cases of stereo sources which contain only two channels, the center extraction is needed to process the audio sources so that the center channel may be extracted from the stereo source. In center extraction, the primary and ambient contents are separated and the contents from the front center sources are synthesized into the center channel. The center extraction can be realized according to coherence and spatial matrix.

After decoding and possible center extraction, at block 406, the N-channel signals can be processed by a psycho-acoustic model such as Head Related Transfer Function (HRTF) filters to enhance the spatial awareness. HRTF filters always come in pairs for left and right ears, so the psycho-acoustic module should contain (N−1)×2 HRTF filters. The filters can be obtained from open-source database and picked up according to the location and angle of the virtual speakers which are supposed to produce the N-channel sources. Note that the signals in C channel (i.e., center channel) should be bypassed without being processed by HRTF filters. This is because that the binaural signals generated by HRTF filters sound better with more sense of direction but sometimes with unnatural coloration. Thus, the psycho-acoustic model can be optional for different channel signals.

Then, at block 408, the signals are merged into three channels of the left, center, and right path. If a subwoofer exists, an additional standalone channel can be generated which contains only low frequency components and is fed directly to the subwoofer. The merging principle is that signals in the channels from left directions (or for left ears if processed by HRTF filters) are merged into the left path, and so is for the right path.

The signals in left path and right path are processed by spatial filters at blocks 410 and 412. Each spatial filter bank contains M filters where M is the number of speakers on the soundbar. The spatial filters are designed to direct the signals in the left path to the left ear and the signals in the right path to the right ear. The details of the spatial filters can be designed by beamforming or cross-talk cancellation techniques. Beamforming and cross-talk cancellation techniques may be applied to realize virtual spatial sound effect. For example, with stereo speakers, cross-talk cancellation may be applied to produce virtual sound field for gaming. In soundbars, beamforming techniques may be used to emit the left, right and surround sound of the movies to side walls in a room environment, for example. Thus, when hearing the reflections from the walls, listeners can perceive the sound coming from virtual sources from the wall instead of real speakers on the soundbar. The spatial filters at blocks 410 and 412 can be adjusted in real-time according to the detected position of the listener's head, as will be described later.

In the meantime, the C channel signals are directly steered to the speaker(s) in front of the listener without spatial filtering, shown at block 414. This makes the audio content in the C channel sound in front of the listener without spatial coloration. The speaker(s) in front of the listener may be one speaker facing directly to the listener or more speakers within a predefined angle range in front of the listener. The predefined angle range may be set by the engineer according to the practice requirement. In other words, the speaker(s) for the C channel signals may be selected adaptively based on the listener's location. According to one or more embodiments, the adaption method of the disclosure may comprise at least one of the following, the coefficients of the spatial filters may be adjusted adaptively based on the location information, and the speaker(s) for the C channel signals may be selected adaptively based on location information.

It can be understood that the discussed method above can be implemented by a processor included in the soundbar. The processor may be any technically feasible hardware unit configured to process data and execute software applications, including without limitation, a central processing unit (CPU), a microcontroller unit (MCU), an application specific integrated circuit (ASIC), a digital signal processor (DSP) chip and so forth.

Finally, the audio signals may be sent to the multi-channel Digital Analog Converters (DAC) or soundcards at block 416, and then to the amplifier at block 418, for example. The amplified analog signals are produced by the speakers on the soundbar at block 420.

The proposed method in the present disclosure can be applied to process with various common source configurations from 2.1 channels to 7.1.4 channels. A detailed example of the virtual sound system fed with audio sources represented by a 7.1 channel decoded in Dolby format is shown in FIG. 5. For example, the audio material at block 502 may be decoded. The decoded 7.1-channel signals may be filtered by HRTF to produce binaural signals if needed. In this example, the signals in Left, Right, Left Surround, Right Surround, Left Rear Surround, and Right Rear Surround (which are abbreviated as L, R, Ls, Rs, Lrs, Rrs in the following) channels are filtered respectively by HRTF filters at blocks 504 and 506. In this example, each channel of L, R, Ls, Rs, Lrs, Rrs channels should be filtered by the left ear and right ear HRTF filters at blocks 504 and 506 to generate signals for both ears. So 6×2 HRTF filters are needed, with 3×2 filters in each HRTF block in FIG. 5. The HRTF filter pairs for each channel may be chosen according to the direction of the corresponding virtual speaker. For example, the angle of the L, R, Lr, Rr, Lrs, and Rrs speakers in the 7.1 audio system can be referred to the Dolby recommendations. In this example, the Center and Low Frequency Effect (which are abbreviated as C and LFE in the following) channel should be bypassed instead of being filtered by HRTF filters 504 and 506 to avoid spatial coloration.

The signals after HRTF filtering are merged into two channels. The signals for the left ear are merged into the left path and the signals for the right ear are merged into the right path. Then, the signals in left and right paths are filtered by spatial filters at blocks 508 and 510 respectively, to generate binaural signals for the left ear and right ear. At blocks 508 and 510, the parameters of the spatial filters may be adaptively adjusted based on the detected location information associated with the listener's movement. After that, the filtered binaural signals are sent and produced by the corresponding speakers. In the process, some super-high frequency components (for example, the cut-on frequency may be chosen from 8 kHz to 11 kHz) can be sent to the twitter or horn at the end of the bar without spatial filtering. Meanwhile, the C and LFE channel should be bypassed without spatial filtering. The C channel signals are steered to the speaker(s) in front of the listener at block 512, and the LFE signals are steered to the subwoofer or mixed into each speaker. The speaker(s) in front of the listener may be adaptively switched according to the listener's position.

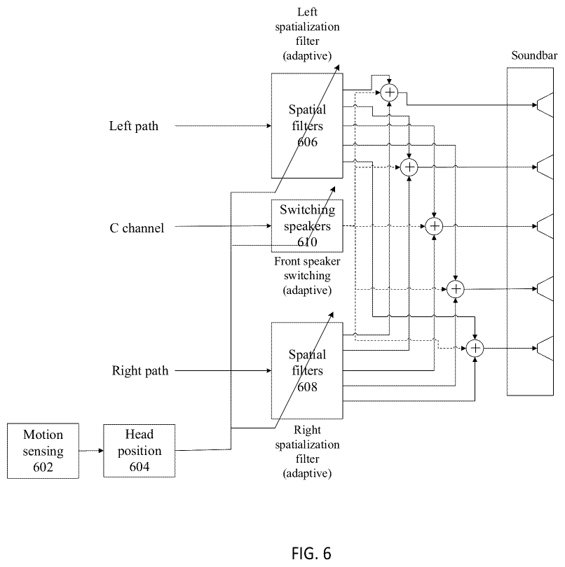

FIG. 6 illustrates an exemplary adaptation of the audio system based on the location tracking according to one or more embodiments. As discussed above, the audio system (e.g., soundbar) in the present disclosure produces the sound according to the real-time detected location (especially the detected head position) of the listener by the motion-sensing apparatus (such as motion sensors including a TOF camera, a radar, an ultrasound detector or combination thereof, for example at block 602). The head position shown at block 604 influences the parameters of the audio system mainly in two ways, as shown in FIG. 6. According to one or more embodiments, spatial filters at blocks 606 and 608 should be adapted to the head position. As one example, the coefficients of the spatial filters are different and should be calculated each time according to the listener's location. As another example, a computationally efficient solution is to store a set of pre-defined spatial filters for all possible locations. In practice, the detected location may not be exactly right corresponding to any one of the stored possible locations. In this case, some locations may be selected based on some criterion. For example, the locations whose difference from the detected location is within a predetermined range can be considered as those locations closest to the actual detected location and can be selected. Then, the real-time spatial filter parameters can be obtained by interpolation of filters associated with those selected locations.

According to another one or more embodiments, the C channel may be switched adaptively to the speaker(s) based on the detected location of the listener, for example, shown at block 610. For example, the signals from the C channel should always be steered to one or more speakers in front of the listener to make the sound image stable. The dashed arrows in FIG. 6 show this adaptive speaker switching for the signals of the C channel.

In this disclosure, a new solution is provided to cover limited sweet spot for the virtual surround technology with proposed tracking alternatives. The adaptive filter structure enables dynamic swapping of the spatial filters without audio artifacts and the motion sensor enables human tracking. By combining the two technologies, the proposed architecture enables wider listening position for virtual surround without compensating privacy and additional hardware for optical modules. In addition, no complex algorithms are needed, and accordingly the computing time is saved, and the system robustness is increased. Thus, the listeners can have better listening experience.

1. In some embodiments, a method of virtualized spatial audio comprising: tracking, by a motion sensor, a listener's movement; obtaining location information associated with the listener's movement, wherein the location information includes distance information and direction information regarding the listener relative to the motion sensor; and producing virtual sound adaptively based on the location information associated with the listener's movement.

2. The method according to clause 1, wherein the producing virtual sound adaptively based on the location information comprises: decoding audio material into multi-channel signals; and merging the multi-channel signals into channels of left, center and right path and outputting signals of left path, center path and right path; processing the signals of the left path and the right path by spatial filters, and outputting the processed signals of the left path and the right path, wherein the spatial filters are adaptively adjusted based on the location information; and producing the virtual sound based on the processed signals of the left path and the right path and the signals of the center path which are not processed by the spatial filters.

3. The method according to any one of clauses 1-2, wherein the signals of the center path are directly steered to one speaker or more speakers in front of the listener based on the location information.

4. The method according to any one of clauses 1-3, wherein before the merging, the multi-channel signals are optionally processed by Head Related Transfer Function (HRTF) filters to produce binaural signals, wherein center-channel signals in the multi-channel signals are not processed by the HRTF filters.

5. The method according to any one of clauses 1-4, further comprises: merging the binaural signals into channels of left and right path; processing the merged signals of the left path and the right path by spatial filters, and generating the processed signals, wherein the spatial filters are adaptively adjusted based on the location information; and producing the virtual sound based on the processed signals and the center-channel signals in the multi-channel signals.

6. The method according to any one of clauses 1-5, wherein the spatial filters comprises left spatial filters and right spatial filters, and both the number of the left spatial filters and the number of right spatial filters correspond to the number of speakers for producing virtual sound.

7. The method according to any one of clauses 1-6, wherein the motion sensor is at least one of a TOF sensor, a radar, and an ultrasound detector.

8. The method according to any one of clauses 1-7, wherein the spatial filters utilizes at least one of beamforming and cross-talk cancellation.

9. In some embodiments, a system of virtualized spatial audio comprising: a motion sensor, configured to track a listener's movement; and an audio system, configured to: obtain location information associated with the listener's movement based on the tracking by the motion sensor, and produce virtual sound adaptively based on the location information associated with the listener's movement; wherein the location information includes distance information and direction information regarding the listener relative to the motion sensor.

10. The system according to clause 9, wherein the audio system comprises multiple speakers and a processor, and wherein the processor is configured to: decode audio material into multi-channel signals; and merge the multi-channel signals into channels of left, center and right path and outputting signals of left path, center path and right path; process the signals of the left path and the right path by spatial filters, and outputting the processed signals of the left path and the right path, wherein the spatial filters are adaptively adjusted based on the location information; and produce the virtual sound based on the processed signals of the left path and the right path and the signals of the center path which are not processed by the spatial filters.

11. The system according to any one of clauses 9-10, the signals of the center path are directly steered to one speaker or more speakers in front of the listener based on the location information.

12. The system according to any one of clauses 9-11, wherein the processor is configured to optionally process the multi-channel signals using Head Related Transfer Function (HRTF) filters to produce binaural signals, before performing the merging; and wherein center-channel signals in the multi-channel signals are not processed by the HRTF filters.

13. The system according to any one of clauses 9-12, wherein the processor is configured to: merge the binaural signals into channels of left and right path; process the merged signals of the left path and the right path by spatial filters, and generating the processed signals, wherein the spatial filters are adaptively adjusted based on the location information; and produce the virtual sound based on the processed signals and the center-channel signals in the multi-channel signals.

14. The system according to any one of clauses 9-13, wherein the spatial filters comprises left spatial filters and right spatial filters, and both the number of the left spatial filters and the number of right spatial filters correspond to the number of speakers on the audio system.

15. The system according to any one of clauses 9-14, wherein the motion sensor is at least one of a TOF sensor, a radar, and an ultrasound detector.

16. The system according to any one of claims 10-15, wherein the spatial filters utilizes at least one of beamforming and cross-talk cancellation.

17. In some embodiments, a computer-readable storage medium comprising computer-executable instructions which, when executed by a computer, causes the computer to perform the method according to any one of claims 1-8.

The descriptions of the various embodiments have been presented for purposes of illustration but are not intended to be exhaustive or limited to the embodiments disclosed. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to specific described embodiments. Instead, any combination of the preceding features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments, and advantages are merely illustrative and are not considered elements or limitations of the appended claims except where explicitly recited in a claim(s).

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module”, “unit” or “system.”

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective calculating/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the drawings illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to embodiments of the present disclosure, other and further embodiments of the disclosure may be devised without departing from the basic scope thereof, and the scope thereof is determined by the claims that follow.

What is claimed is:

1. A method of virtualized spatial audio, comprising:
tracking, by a motion sensor, a listener's movement;
obtaining location information associated with the listener's movement, wherein the location information includes distance information and direction information regarding the listener relative to the motion sensor; and
producing virtual sound adaptively based on the location information associated with the listener's movement.

2. The method according to claim 1, wherein the producing virtual sound adaptively based on the location information comprises:
decoding audio material into multi-channel signals; and
merging the multi-channel signals into channels of left, center and right path and outputting signals of left path, center path, and right path;
processing the signals of the left path and the right path by spatial filters, and outputting the processed signals of the left path and the right path, wherein the spatial filters are adaptively adjusted based on the location information; and
producing the virtual sound based on the processed signals of the left path and the right path and the signals of the center path which are not processed by the spatial filters.

3. The method according to claim 2, wherein the signals of the center path are directly steered to one speaker or more speakers in front of the listener based on the location information.

4. The method according to claim 2, wherein before the merging, the multi-channel signals are optionally processed by Head Related Transfer Function (HRTF) filters to produce binaural signals, wherein center-channel signals in the multi-channel signals are not processed by the HRTF filters.

5. The method according to claim 4, further comprising:
merging the binaural signals into channels of left and right path;
processing the merged signals of the left path and the right path by spatial filters, and generating the processed signals of the left path and the right path, wherein the spatial filters are adaptively adjusted based on the location information; and
producing the virtual sound based on the processed signals of the left path and the right path and the center-channel signals in the multi-channel signals.

6. The method according to claim 2, wherein the spatial filters comprises left spatial filters and right spatial filters, and both the number of the left spatial filters and the number of right spatial filters correspond to the number of speakers for producing virtual sound.

7. The method according to claim 1, wherein the motion sensor is at least one of a TOF sensor, a radar, and an ultrasound detector.

8. The method according to claim 2, wherein the spatial filters utilize at least one of beamforming and cross-talk cancellation.

9. A system of virtualized spatial audio, comprising:
a motion sensor, configured to track a listener's movement; and
an audio system, configured to:
obtain location information associated with the listener's movement based on the tracking by the motion sensor, and
produce virtual sound adaptively based on the location information associated with the listener's movement;
wherein the location information includes distance information and direction information regarding the listener relative to the motion sensor.

10. The system according to claim 9, wherein the audio system comprises multiple speakers and a processor, and wherein the processor is configured to:
decode audio material into multi-channel signals; and
merge the multi-channel signals into channels of left, center and right path and outputting signals of left path, center path, and right path;
process the signals of the left path and the right path by spatial filters, and outputting the processed signals of the left path and the right path, wherein the spatial filters are adaptively adjusted based on the location information; and
produce the virtual sound based on the processed signals of the left path and the right path and the signals of the center path which are not processed by the spatial filters.

11. The system according to claim 10, wherein the signals of the center path are directly steered to one or more speakers in front of the listener based on the location information.

12. The system according to claim 10, wherein the processor is configured to optionally process the multi-channel signals using Head Related Transfer Function (HRTF) filters to produce binaural signals, before performing the merging; and wherein center-channel signals in the multi-channel signals are not processed by the HRTF filters.

13. The system according to claim 12, wherein the processor is configured to:
merge the binaural signals into channels of left and right path;
process the merged signals of the left path and the right path by spatial filters, and generating the processed signals of the left path and the right path, wherein the spatial filters are adaptively adjusted based on the location information; and
produce the virtual sound based on the processed signals of the left path and the right path and the center-channel signals in the multi-channel signals.

14. The system according to claim 10, wherein the spatial filters comprise left spatial filters and right spatial filters, and both the number of the left spatial filters and the number of right spatial filters correspond to the number of speakers on the audio system.

15. The system according to claim 9, wherein the motion sensor is at least one of a TOF sensor, a radar, and an ultrasound detector.

16. The system according to claim 10, wherein the spatial filters utilizes at least one of beamforming and cross-talk cancellation.
